(19) United States
(12) Patent Application Publication
(10) Pub. No.: US 2014/0327844 A1
(43) Pub. Date: Nov. 6, 2014

(54) TOUCH SCREEN PANEL FOR MULTI-TOUCHING AND METHOD OF MANUFACTURING THE SAME

(71) Applicants: Jun Young Hwang, Yongin-si (KR); Sang Ho Lee, Seoul (KR); Jeong Jin Kang, Seoul (KR); Heui Seok Kang, Seoul (KR); Kyung Tae Kang, Seoul (KR); Sung Ho Lee, Daejeon (KR); Kyung Hoon Yoo, Seoul (KR); Nak Kyu Lee, Incheon (KR); Young June Cho, Yongin-si (KR); Kwon Yong Shin, Seoul (KR); Seok Kwan Hong, Seoul (KR)

(72) Inventors: Jun Young Hwang, Yongin-si (KR); Sang Ho Lee, Seoul (KR); Jeong Jin Kang, Seoul (KR); Heui Seok Kang, Seoul (KR); Kyung Tae Kang, Seoul (KR); Sung Ho Lee, Daejeon (KR); Kyung Hoon Yoo, Seoul (KR); Nak Kyu Lee, Incheon (KR); Young June Cho, Yongin-si (KR); Kwon Yong Shin, Seoul (KR); Seok Kwan Hong, Seoul (KR)

(73) Assignee: KOREA INSTITUTE OF INDUSTRIAL TECHNOLOGY, Cheonan-si, Chungcheongnam-do (KR)

(21) Appl. No.: 14/359,301

(22) PCT Filed: Nov. 22, 2012
(86) PCT No.: PCT/KR2012/009914

§ 371 Date: May 20, 2014

(30) Foreign Application Priority Data
Dec. 23, 2011 (KR) 10-2011-0141265

(51) Int. Cl. G06F 1/16; B32B 37/00; B32B 37/18

(52) U.S. Cl. CPC G06F 1/16; B32B 37/18; B32B 37/0038; B32B 2307/73; B32B 2310/0409; B32B 2310/0843; B32B 2310/0831; B32B 2311/22
USPC 349/12; 156/60; 156/277; 156/272.8; 156/325; 156/310; 156/273.3; 156/245

(57) ABSTRACT

Disclosed herein is a method of manufacturing a touch screen panel, including the steps of: forming a spacer array and a mold having a shape corresponding to that of a horizontal groove array or a vertical groove array; fabricating a transparent upper plate having a horizontal groove array including two or more horizontal grooves and a transparent lower plate having a vertical groove array including two or more vertical grooves using the mold; charging a predetermined amount of conductive ink in the horizontal groove array and the vertical groove array; and drying the conductive ink to form a conductive array and then attaching the upper plate to the lower plate.

### TECHNICAL FIELD

The present invention relates to a touch screen panel and a method of manufacturing the same, and, more particularly, to a touch screen panel for multi-touching and a method of manufacturing the same.

### BACKGROUND ART

As a touch screen system has been introduced into user interfaces of various electronic appliances, various touch panels for realizing a touch screen have also been introduced. Table 1 below shows the results of analyzing the characteristics, application fields, application markets and disadvantages of typical touch panels according to the kinds thereof.

TABLE 1

| | | Four-wire | | Power failure + | Ultrasonic |
|---|---|---|---|---|---|
| Type | Power failure | resistive film | Infrared (IR) | digitizer | waves |
| Multi-touch | possible | impossible | possible | possible | Impossible/ |
| Writing | impossible | possible | possible | possible | possible |
| Transmittance | 90% | 85% | 100% | 85% | 100% |
| Application field | middle and | middle and | large size | middle size | large size |
| | small size (14″ | small size (21″ | (14″ or more) | (14″) | |
| | or less) | or less) | | | |
| Application | mobile | navigations | advertisement of | notebooks | electronic |
| market | phones, Tabs | mobile | 40″ or more | | blackboards |
| | | phones, POS | | | |
| Disadvantage | noise | multi-touch | price (IR | price (?) | noise |
| | malfunction | | LED number) | | malfunction |
| | (IC | Field visibility | Field noise | Instrumental | |
| | performance) | | malfunction | problems | |
| The others | lare-size | multi-touch | | writing | Projector |
| | appliance | technology | | problems | applicable |
| | developed by | developed | | overcome by | |
| | Zytronics | | | Ntrig | |
| | Corporation | | | Corporation | |

Currently, as a transparent electrode material, indium tin oxide (ITO) is frequently used by sputtering. However, when ITO is used, there are problems in that an ITO layer is not suitable for flexible substrates because its flexibility is poor, and in that it is costly to form an ITO layer.

Due to the above problems, novel materials and process technologies are required in order to apply ITO to low-priced flexible elements. Thus, in order to replace ITO with microelectrode wires using electronic printing, there has been required a novel touch screen panel manufacturing method, which can assure the reliability of uniform electrode wires by overcoming the problem of difficulty in forming thin and uniform electrode wires using inkjet printing, which can enhance the durability of electrode wires by minimizing the occurrence of damage to electrode wires and insufficient adhesion between electrode wires and a substrate.

### PRIOR ART DOCUMENTS

(Patent document 1) 1020040103129 A

(Patent document 2) 1020060100584 A

(Patent document 3) 1020060122217 A

(Patent document 4) 1020090039803 A

(Patent document 5) 1020090101310 A

(Patent document 6) 1020090101313 A

(Patent document 7) 1020070132251 A

(Patent document 8) JP-P-2001-0020584

(Patent document 9) US10/017,268

### DISCLOSURE

### Technical Problem

Accordingly, the present invention has been devised to solve the above-mentioned problems, and a first object of the present invention is to provide a touch screen panel for multi-touching.

A second object of the present invention is to provide a method of manufacturing a touch screen panel for multi-touching.

### Technical Solution

In order to accomplish the above objects, an aspect of the present invention provides method of manufacturing a touch screen panel, including the steps of: (A) preparing a transparent upper plate having a horizontal groove array including two or more horizontal grooves having a channel shape of predetermined depth and width and a transparent lower plate having a vertical groove array including two or more vertical grooves having a channel shape of predetermined depth and width; (B) charging conductive ink in the horizontal groove array and the vertical groove array and then treating the conductive ink to form a conductive array; and (C) attaching the upper plate to the lower plate.

The method may further include the step of forming a spacer array having a predetermined height on at least one of the upper plate and the lower plate.

The spacer array may be formed by any one of a first process micropatterning a liquid resin or polymer solution on at least one of the upper plate and the lower plate using screen printing and then drying the liquid resin or polymer solution and a second process of applying a microball-dispersed or microcapsule-dispersed solution onto at least one of the upper plate and the lower plate.

The amount of the conductive ink may be adjusted such that convex portions having a predetermined shape are formed in the horizontal grooves and vertical grooves.

The conductive ink may be treated by any one of a first process of heating the conductive ink to room temperature or predetermined temperature for predetermined time to dry the conductive ink and a second process of additionally heating the conductive ink dried in the first process using laser heat or electric heating to sinter the conductive ink to improve the conductivity thereof.

The height of the convex portions may be lower than that of the spacer array by a predetermined difference, and thus the convex portions of the upper plate may be spaced apart from the convex portions of the lower plate such that they are brought into contact with each other even when the lower plate is attached to the lower plate.

The conductive ink may be charged using an inkjet printer.

The conductive ink may be at least one of metal nanoparticle ink and conductive polymer ink.

The metal nanoparticle ink may include at least one of silver, copper and gold, and the conductive polymer ink may include at least one of poly(3,4-ethylenedioxythiophene) (PEDOT) and polyaniline (PANI).

The diameter of droplets of the conductive ink is greater than the width of the channel shape when the conductive ink is charged.

The method may further include the step of (B2) hydrophobic-coating the surface of the upper plate and the surface of the lower plate, before the step (B).

The method may further include the step of (B3) UV-irradiating the surface of the upper plate and the surface of the lower plate, before the step (B).

Each of the upper plate and the lower plate may be a flexible substrate, and may be made by the thermal imprinting of a thermoplastic material or the UV molding of a UV-curable material.

A spacer array may be formed on at least one of the upper plate and the lower plate in the step (A), and the spacer array may be made of the same material as the upper plate or the lower plate.

The spacer array may be formed simultaneously with the formation of the upper plate or the lower plate, and the spacer array, the horizontal groove array and the vertical groove array may be formed using a mold having a predetermined shape.

When the engraved horizontal groove array, the engraved vertical groove array and the embossed spacer array are formed using the mold, the mold may be coated with an anti-sticking layer, and then hot embossing is used.

The mold may be a nickel stamper, and the nickel stamper may be fabricated by a process of fabricating an inkjet groove pattern master using photo-etching, a process of fabricating a spacer pattern master using photo-etching or a process of fabricating a nickel stamper using electro-forming.

In order to accomplish the above objects, another aspect of the present invention provides a method of manufacturing a touch screen panel, including the steps of: (D) forming a spacer array and a mold having a shape corresponding to that of a horizontal groove array or a vertical groove array; (E) fabricating a transparent upper plate having a horizontal groove array including two or more horizontal grooves and a transparent lower plate having a vertical groove array including two or more vertical grooves using the mold; (F) charging a predetermined amount of conductive ink in the horizontal groove array and the vertical groove array; and (G) drying the conductive ink to form a conductive array and then attaching the upper plate to the lower plate.

The step of forming the mold may include the steps of: (D1) forming a groove pattern master using photolithography; (D2) forming a spacer pattern master using photolithography; and (D3) forming a metal stamper using electro-forming.

In order to accomplish the above objects, still another aspect of the present invention provides a touch screen panel, manufactured by the method.

In order to accomplish the above objects, still another aspect of the present invention provides a touch screen panel, including: a transparent upper plate having a horizontal groove array including two or more horizontal grooves having a channel shape of predetermined depth and width; a transparent lower plate having a vertical groove array including two or more vertical grooves having a channel shape of predetermined depth and width; an upper conductive array formed in the horizontal groove array of the upper plate and made of conductive ink; a lower conductive array formed in the vertical groove array of the lower plate and made of conductive ink; and a spacer array formed on at least one of the upper plate and the lower plate, wherein the upper plate and the lower plate are attached to each other.

The spacer array may be made of the same material as the upper plate or the lower plate, and the spacer array may be integrated with the upper plate or the lower plate without the interfacial boundary therebetween.

The spacer array may be formed by applying a predetermined spacer forming material onto the upper plate or the lower plate.

The width of the channel shape may be equal to or greater than the depth thereof.

The upper conductive array may have convex portions protruding from the surface of the upper plate by a predetermined height, and the lower conductive array may have convex portions protruding from the surface of the lower plate by a predetermined height.

The spacer array has a sufficient height, so the upper conductive array and the lower conductive array may be spaced apart from each other at a predetermined interval as long as external pressure is not applied to at least one of the upper plate and the lower plate.

The upper plate and the lower plate may be made of a flexible thermoplastic resin or a UV-curable material.

The conductive ink may be at least one of metal nanoparticle ink and conductive polymer ink.

The spacer array may be formed in two or more selected from among a plurality of lattice spaces forming the horizontal groove array and the vertical groove array, or the spacer array may be formed with respect to each of a plurality of lattice spaces forming the horizontal groove array and the vertical groove array.

### Advantageous Effects

When the present invention is used, there are advantages as follows.

First, thin, continuous and uniform wiring can be formed, compared to when conventional flat substrate printing is used, thus increasing the light transmittance of a product and the reliability of a manufacturing process.

Second, the adhesion between wiring and a substrate is increased, compared to when conventional flat substrate printing is used, so damage to wiring is decreased, thereby improving the durability of wiring.

Third, since the electrode wiring of the present invention has excellent flexibility compared to a conventional ceramic transparent conductive oxide (TCO) electrode wiring, it is more suitable for flexible substrates.

Fourth, the number of processes and process cost of the present invention using printing is remarkably decreased, compared to a conventional TCO electrode process using sputtering or deposition.

Fifth, since the present invention uses printing or imprinting, it easily copes with large-area TSP for windows and doors or large-size screens.

### DESCRIPTION OF DRAWINGS

FIG. 1 is an exploded view showing a touch screen panel including an upper plate, a lower plate, conductive arrays, window lines, bezel lines and contact pads according to an embodiment of the present invention.

FIG. 2 is a schematic view showing a touch screen panel according to an embodiment of the present invention.

FIG. 3 is a block diagram showing a method of manufacturing a touch screen panel according to an embodiment of the present invention.

FIG. 4 is a sectional view showing a groove-formed substrate of a touch screen panel according to an embodiment of the present invention.

FIG. 5 is a sectional view showing a procedure of charging conductive ink into the grooves of FIG. 4.

FIG. 6 is a perspective view showing a substrate provided with a conductive array and convex portions after charging ink in horizontal grooves. The conductive array is formed by charging conductive ink into grooves and then drying the conductive ink.

FIG. 7 is a photographic image showing a substrate provided with a conductive array and convex portions after charging ink. Here, the substrate is provided with convex portions.

FIG. 8 is a photographic image of a touch screen panel according to an embodiment of the present invention.

FIG. 9 is a photographic image showing the thickness of a bezel line of the touch screen panel of FIG. 8.

FIG. 10 is a photographic image showing the thickness of a contact pad of the touch screen panel of FIG. 8.

FIG. 11 is a photographic image showing the inkjet-printed bezel lines and contact pads according to an embodiment of the present invention.

FIG. 12 is a photographic image showing the thickness of a bezel line of the touch screen panel of FIG. 11.

FIG. 13 is a photographic image showing the thickness of a contact pad of the touch screen panel of FIG. 11.

FIG. 14 is a block diagram showing another method of manufacturing a touch screen panel including the step of forming a spacer according to an embodiment of the present invention.

FIG. 15 is a block diagram showing still another method of manufacturing a touch screen panel according to an embodiment of the present invention.

FIG. 16 is a sectional view showing a process of forming a photoresist (PR) on a silicon wafer using spin coating during a process of fabricating an ink-jet groove pattern master using photolithography according to an embodiment of the present invention.

FIG. 17 is a sectional view showing a process of selectively UV-exposing the photoresist (PR) using a photomask during a process of fabricating an ink-jet groove pattern master using photolithography according to an embodiment of the present invention.

FIG. 18 is a sectional view showing a process of partially removing the photoresist (PR) using development during a process of fabricating an ink-jet groove pattern master using photolithography according to an embodiment of the present invention.

FIG. 19 is a sectional view showing a process of partially etching the silicon wafer using reactive-ion etching (RIE) during a process of fabricating an ink-jet groove pattern master using photolithography according to an embodiment of the present invention.

FIG. 20 is a sectional view showing an ink-jet groove pattern master 625 formed after removing residual photoresist (PR) during a process of fabricating the ink-jet groove pattern master 625 using photolithography according to an embodiment of the present invention.

FIG. 21 is a sectional view showing a process of forming a photoresist (PR) on a silicon wafer using spin coating during a process of fabricating a spacer pattern master using photolithography according to an embodiment of the present invention.

FIG. 22 is a sectional view showing a process of selectively UV-exposing the photoresist (PR) using a photomask during a process of fabricating a spacer pattern master using photolithography according to an embodiment of the present invention.

FIG. 23 is a sectional view showing a process of partially removing the photoresist (PR) using development during a process of fabricating a spacer pattern master using photolithography according to an embodiment of the present invention.

FIG. 24 is a sectional view showing a process of forming a spacer pattern through reflowing during a process of fabricating a spacer pattern master using photolithography according to an embodiment of the present invention.

FIG. 25 is a sectional view showing a process of depositing a nickel (Ni) seed layer through nickel (Ni) evaporation during a process of fabricating a nickel (Ni) stamper using electro-forming according to an embodiment of the present invention.

FIG. 26 is a sectional view showing a process of reproducing a pattern through nickel (Ni) electro-forming during a process of fabricating a nickel (Ni) stamper using electro-forming according to an embodiment of the present invention.

FIG. 27 is a sectional view showing a nickel (Ni) stamper reproduced after separating/removing a master during a process of fabricating the nickel (Ni) stamper using electro-forming according to an embodiment of the present invention.

FIG. 28 is a sectional view showing a process of applying an anti-sticking layer through a self assembly monolayer (SAM) process during a process of fabricating a touch panel substrate using hot embossing according to an embodiment of the present invention.

FIG. 29 is a sectional view showing a process of forming groove and spacer patterns through hot embossing during a process of fabricating a touch panel substrate using hot embossing according to an embodiment of the present invention.

FIG. 30 is a sectional view showing a process of producing a touch panel substrate fabricated after demolding during a process of fabricating a touch panel substrate using hot embossing according to an embodiment of the present invention.

### DESCRIPTION OF THE REFERENCE NUMERALS IN THE DRAWINGS

10: touch screen panel 100: upper plate
200: lower plate 300: spacer array
310: spacer 400: groove array
410: horizontal groove array 420: vertical groove array
500: conductive array 510: charged conductive ink
530: conductive array of upper plate 530-1: conductive array of lower plate
540: convex portion 550: flat portion
20: bezel line 30: window line
40: contact pad 610: silicon wafer
620: photoresist 625: ink-jet groove pattern master
630: mask 635: spacer pattern
640: groove 650: nickel seed layer
660: nickel stamper (nickel-made mold) 670: anti-sticking layer
680: polymer 690: substrate
695: mold 700: inkjet printer
710: inkjet printer nozzle

### BEST MODE

Hereinafter, preferred embodiments of the present invention will be described in detail with reference the accompanying drawings.

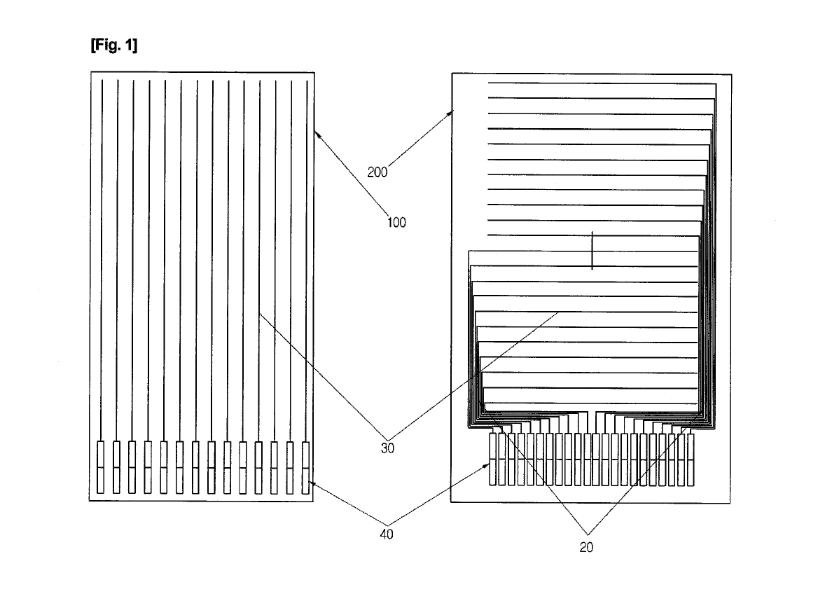

FIG. 1 is an exploded view showing a touch screen panel 10 including an upper plate 100, lower plate 200, conductive arrays 500, window lines 30, bezel lines 20 and contact pads 40 according to an embodiment of the present invention. The touch screen panel 10 includes an upper plate 100 and a lower plate 200, and each of the upper plate 100 and lower plate 200 is provided with a conductive array 500.

FIG. 2 is a schematic view showing a touch screen panel 10 according to an embodiment of the present invention. The touch screen panel 10 is provided at the outer side thereof with bezel lines 20, and is provided at the center thereof with window lines 30. Further, the touch screen panel 10 is provided with contact pads 40 for bringing a device into contact with the touch screen panel 10. In the present invention, the bezel lines 20 and/or the contact pads 40 are characterized in that they have conductivity because they are printed with conductive ink using an electronic printing method.

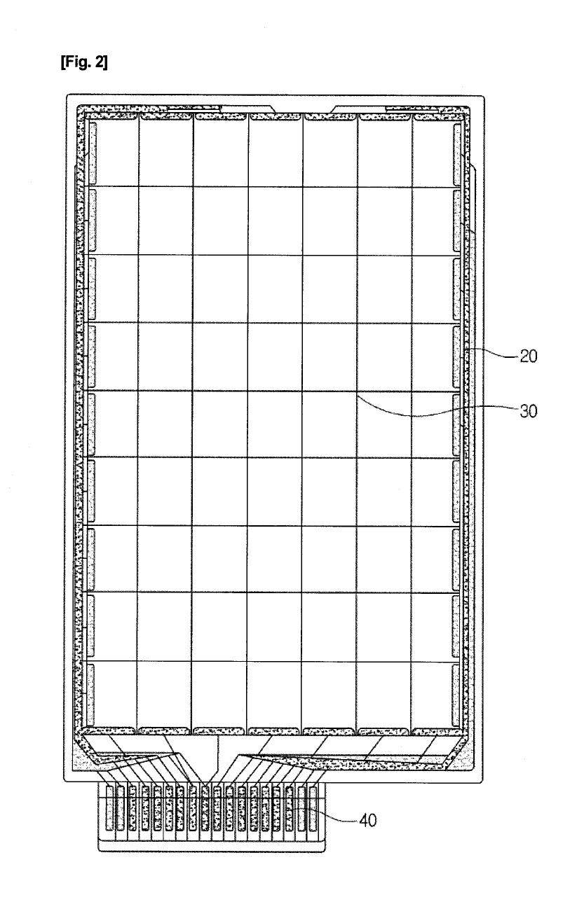

FIG. 3 is a block diagram showing a method of manufacturing a touch screen panel 10 according to an embodiment of the present invention. The method of manufacturing a touch screen panel 10 includes the steps of: (S11) providing a transparent upper plate 100 having a horizontal groove array 410 including two or more horizontal grooves and a transparent lower plate 200 having a vertical groove array 420 including two or more vertical grooves; (S12) charging the horizontal groove array 410 and the vertical groove array 420 with conductive ink; (S13) drying the conductive ink to form a conductive array 500 and attaching the upper plate 100 to the lower plate 200; and (S14) forming a spacer array 300.

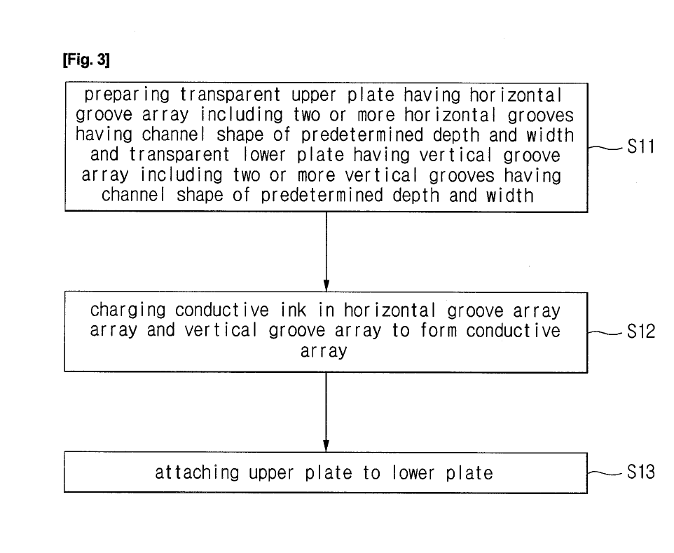

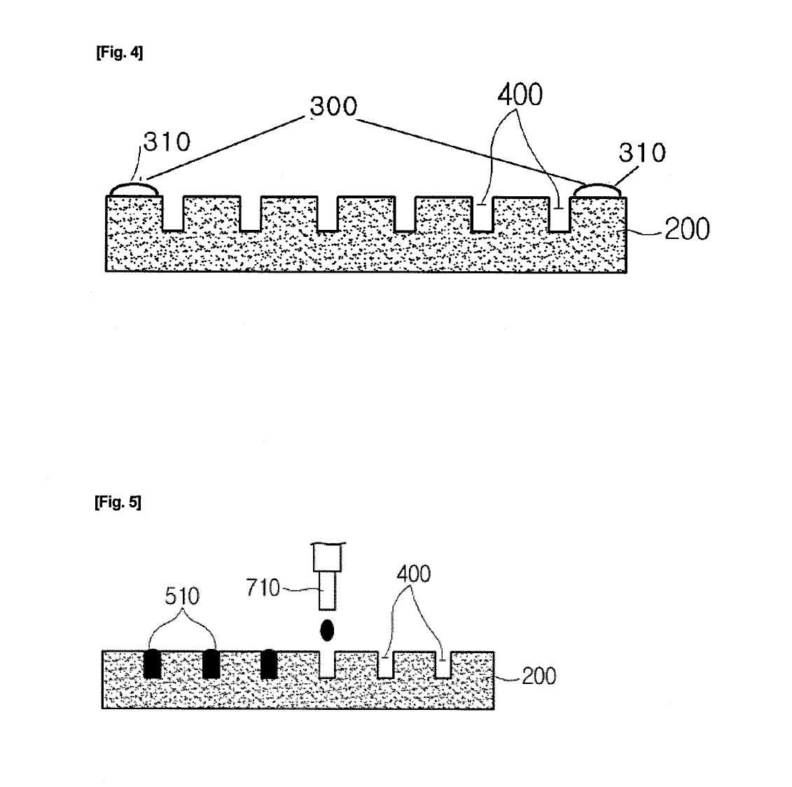

FIG. 4 is a sectional view showing a groove-formed substrate of a touch screen panel 10 according to an embodiment of the present invention. Each of the upper plate 100 and the lower plate 200 may be a flexible substrate, and may be made by the thermal imprinting of a thermoplastic material or the UV molding of a UV-curable material. The upper plate 100 is provided with a vertical groove array 420 including two or more vertical grooves having a channel shape having predetermined depth and width, and the lower plate 200 is provided with a horizontal groove array 410 including two or more horizontal grooves having a channel shape having predetermined depth and width. The upper plate 100 and the lower plate 200 are made of a transparent material. It is a matter of course that the upper plate 100 is provided with horizontal grooves, and the lower plate 200 is provided with vertical grooves. From FIG. 4, it can be seen that a spacer array 300 including two or more spacers 310 is formed. The spacer array 300 may be formed by the following spacer formation method after the formation of a conductive array 500, and may also be formed by a mold 695 or the like before the formation of the conductive array 500.

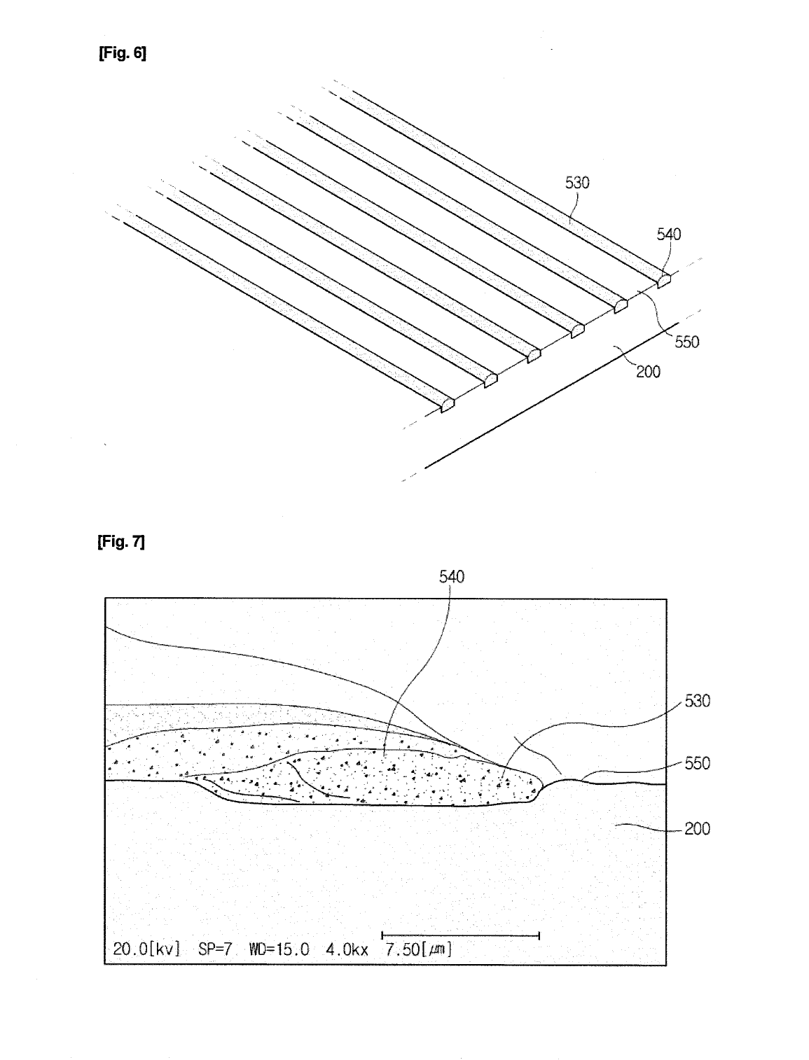

As shown in FIG. 4 or 6, the upper plate or the lower plate is provided with a horizontal groove array 410 including two or more horizontal grooves having a channel shape of predetermined depth and width or a vertical groove array 420 including two or more vertical grooves having a channel shape of predetermined depth and width. The horizontal groove array 410 and the vertical groove array 420 may have a concave shape or a U-shape. The depth of grooves can be maintained when the horizontal groove array 410 and the vertical groove array 420 have a concave shape, and can be changed when the horizontal groove array 410 and the vertical groove array 420 have a U-shape. In the horizontal groove array 410 and the vertical groove array 420, it is preferred that grooves be formed by hot-embossing the upper plate 100 or the lower plate 200 made of a thermoplastic polymer (for example, polyethylene naphthalate (PEN)) at predetermined temperature and pressure using the previously fabricated stamper. The grooves may also be formed by hot-embossing the upper plate 100 or the lower plate 200 made of a UV-curable polymer resin using a stamp-shaped mold 695. The grooves correspond to horizontal grooves or vertical grooves.

FIG. 5 is a sectional view showing a procedure of charging conductive ink into the grooves 400 of FIG. 4. When conductive ink is charged in the grooves 400, the droplets of conductive ink must have a larger diameter than a width of channel-shaped grooves in terms of the drying of conductive ink and the effective formation of a conductive array 500.

The conductive ink charged in the grooves 400 is dried to form a conductive array 500. It is preferred that the conductive ink be metal nanoparticle ink or conductive polymer ink. The metal nanoparticle ink may include one or more of silver, copper and gold, and the conductive polymer ink may include one or more of poly(3,4-ethylenedioxythiophene) (PEDOT) and polyaniline (PANI). The conductive ink must have other physical properties, such as viscosity, surface tension and the like, in addition to conductivity.

In the present invention, the conductive ink is charged in the grooves by an inkjet printer. As an example of inkjet printer, there is a multi-inkjet printer, manufactured by Dimatrix Corporation. This multi-inkjet printer has a nozzle diameter of 9 to 19 μm. The multi-inkjet printer is configured such that a stage for moving a substrate by synchronizing the substrate with drive signals has a drive precision of several micrometers (μm), and the temperature of a nozzle head and a substrate is controlled by integrating the stage and nozzle head with a temperature controller. Further, the multi-inkjet printer is configured such that, in order to observe the droplets of charged conductive ink, high-brightness LED light sources and CCD cameras synchronized with signals for driving inkjet are arranged, thus observing the spray characteristics, such as droplet size, charging speed, droplet route and the like, according to electrical drive signals, and such that nozzles are aligned to spray droplets to desired locations by compensating the position information of droplets injected through nozzles, the origin of injected patterns, the angle of a substrate located on the stage and the like using a fiducial camera spaced apart from the nozzle at a predetermined offset distance.

The inkjet printer of the present invention configured such that the behavior of droplets sprayed through nozzles can be controlled by changing the wave form attributable to the change of voltage according to applied time, and conductive ink can be sprayed through nozzles by a single cycle or a combination of cycles having a sine wave form as a function consisting of voltage, rise time, dwell time, fall time, echo time and final rise time. When the relation between voltage and applied time is maintained stable, droplets are stably sprayed through nozzles, and when the relation therebetween is unstable, droplets are not sprayed or are unstably sprayed.

The conductive ink is charged in the horizontally and vertically-formed groove arrays 400 by an inkjet printer, and then dried to remove a solvent from the conductive ink, thus forming a conductive pattern. Then, the conductive pattern is heated and sintered by heat, electricity, laser or the like, thereby improving the conductivity of the conductive pattern.

FIG. 6 is a perspective view showing a substrate provided with a conductive array and convex portions after charging the conductive ink in the grooves. As shown in FIG. 6, it can be seen that the grooves formed on the upper plate 100 are charged with conductive ink in the same manner as in FIG. 5 to form an upper conductive array 530, and the conductive array 530 is formed in a convex shape (refer to the photographic image of FIG. 7), so convex portions 540 protruding from flat portions 550 exist on the upper plate 100. Similarly, it can be seen that the grooves formed on the lower plate 200 are charged with conductive ink in the same manner as in FIG. 5 to form a lower conductive array 530-1, and the conductive array 530-1 is formed in a convex shape (refer to the photographic image of FIG. 7), so convex portions 540 protruding from flat portions 550 exist on the lower plate 200.

FIG. 7 is a photographic image showing a substrate provided with a conductive array 500. As shown in FIG. 7, it can be seen that the conductive array 500 is provided with convex portions 540 protruding from flat portions 550 of the upper plate 100 or the lower plate 200. The height of the convex portions 540 may be set such that the convex portions 540 of the upper plate 100 are spaced apart from the convex portion 540 of the lower plate 200 to such a degree that they do not make contact with each other even when the upper plate 100 is attached to the lower plate 200. The height of the convex portions 540 may be higher than that of the flat portions 550, and may be lower than the depth of the grooves. Specifically, the height of the convex portions 540 may be higher than that of the flat portions 550 by 0.1 to 100 um. In this case, when the height of the convex portions of the conductive array 500 is lower than 0.1 um, there is a problem of the upper and lower plates 100 and 200 not being in contact with each other at the time of pressing the upper and lower plates 100 and 200, and, when the height thereof is excessively higher than the depth of the conductive array 500, there is a problem of decreasing the flexibility of the conductive array 500.

As shown in FIG. 7, it can be seen that the horizontal width of the conductive array 500 is greater than the vertical depth thereof.

The formation of the conductive array 500 can be checked by a substrate analysis apparatus. The groove width (line width) of the conductive array 500 may be analyzed by a DZ-2 microscope, and the groove depth (line depth) thereof may be analyzed by an alpha step IQ. The substrate analysis apparatus may be FESEM or S-4000, and may have the following specifications of 1) Magnification: 20× to 300,000, 2) Accelerating Voltage: 0.5 to 30 kV, and 3) Resolution: 1.5 nm guaranteed at 30 kV with a working distance of 5 nm.

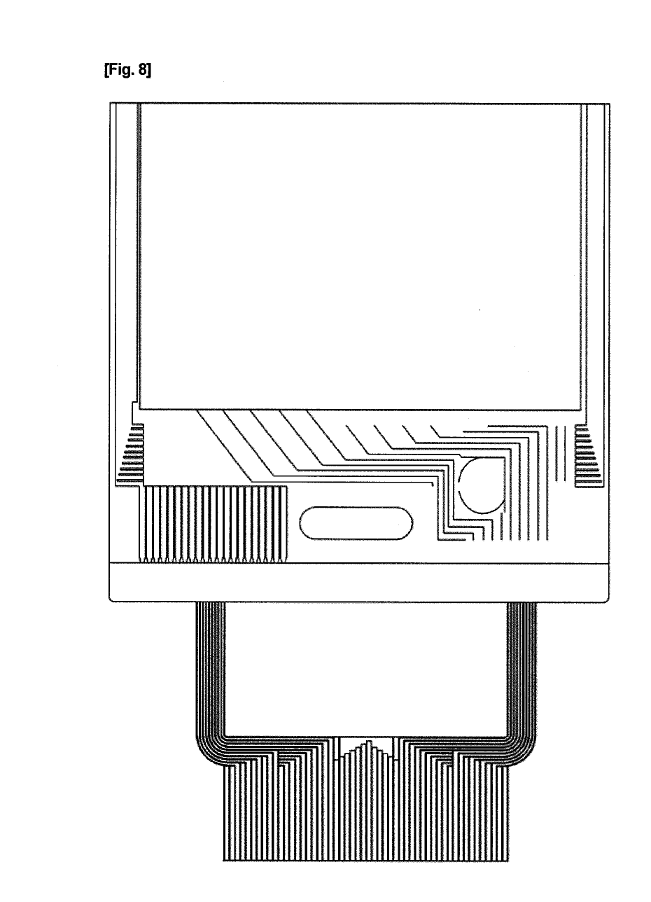

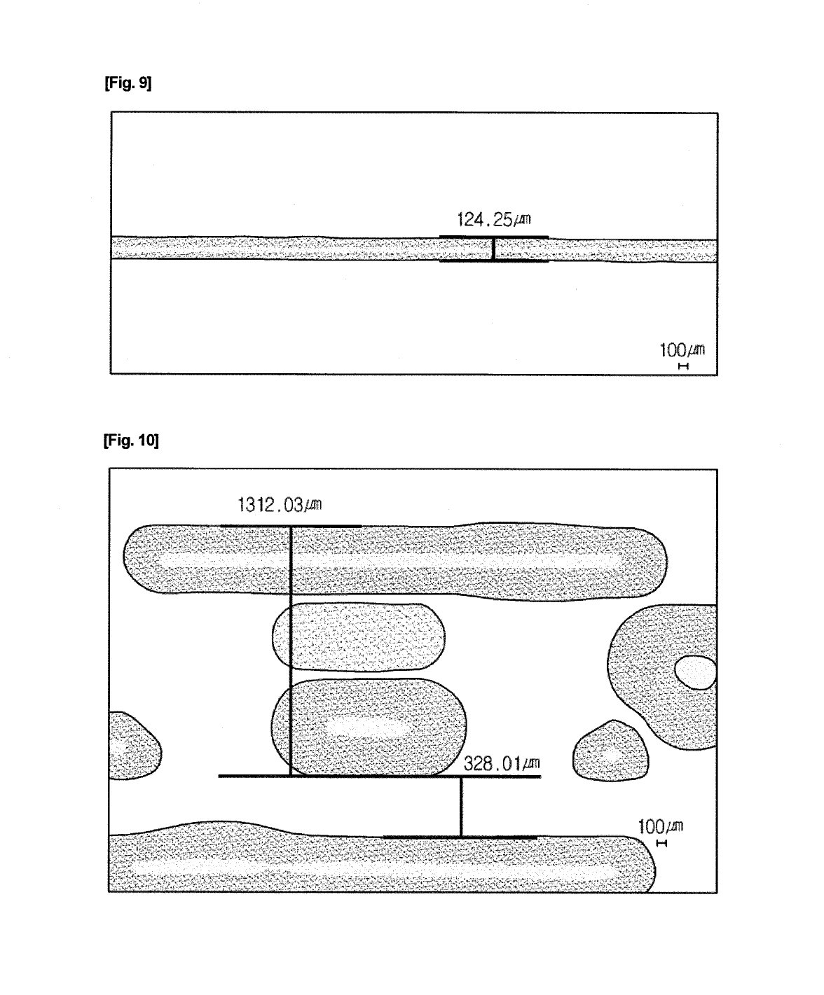

FIG. 8 is a photographic image of a touch screen panel 10 according to an embodiment of the present invention, FIG. 9 is a photographic image showing the thickness of the bezel line 20 of the touch screen panel 10 of FIG. 8, and FIG. 10 is a photographic image showing the thickness of the contact pad 40 of the touch screen panel 10 of FIG. 8. As shown in FIGS. 9 to 10, in the present invention, a method of printing the bezel lines 20 and the compact pads 40 with conductive ink is employed.

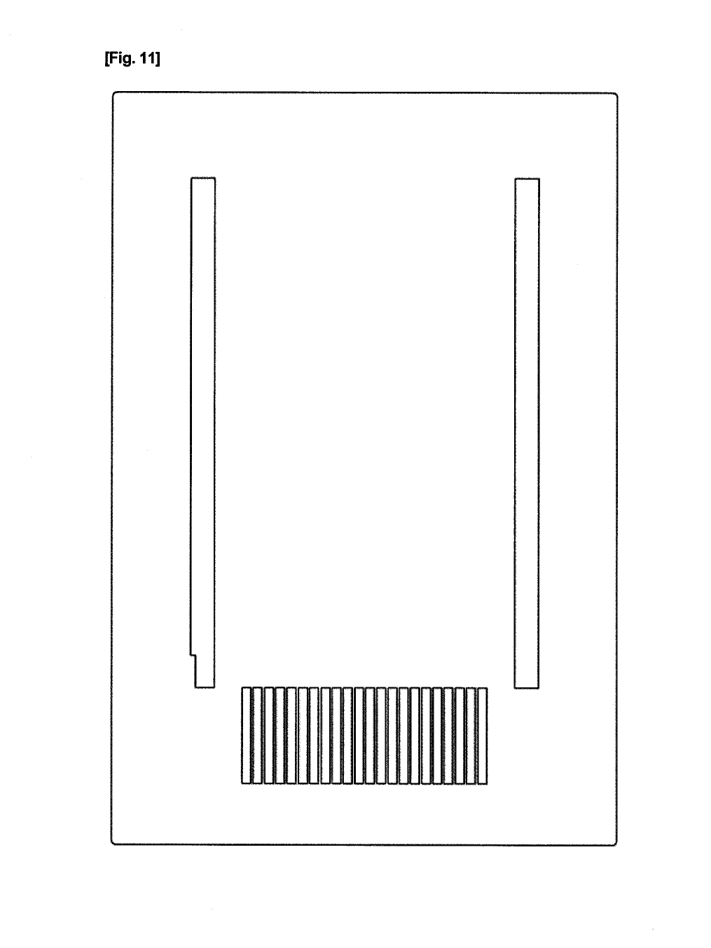

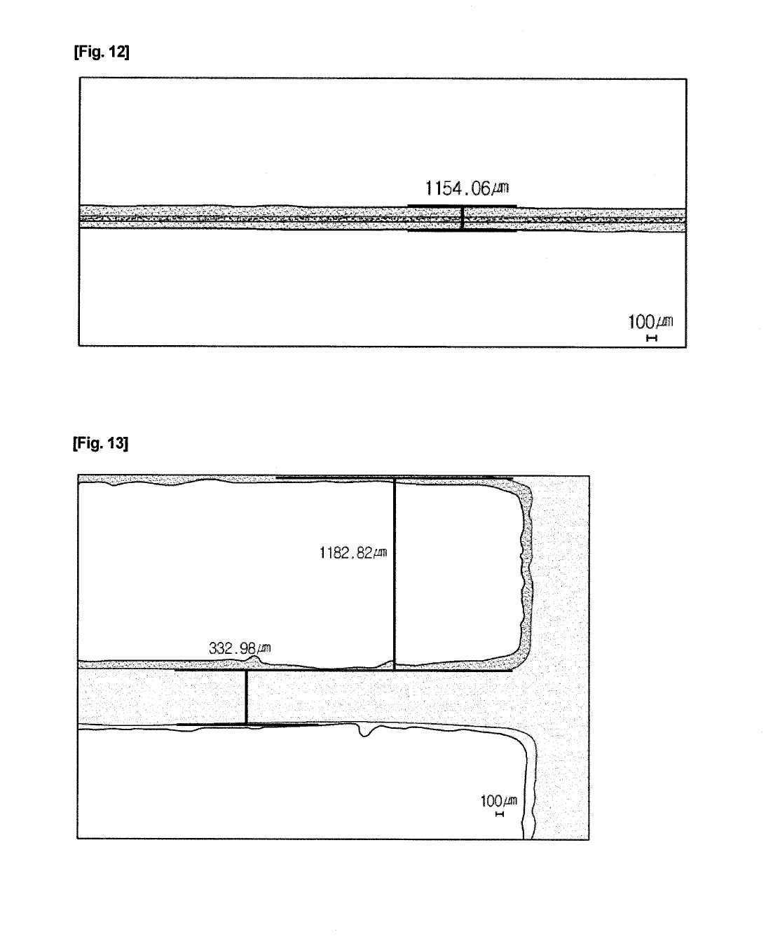

FIG. 11 is a photographic image showing the inkjet-printed bezel lines 20 and contact pads 40 according to another embodiment of the present invention, FIG. 12 is a photographic image showing the thickness of the bezel line 20 of the touch screen panel 10 of FIG. 11, and FIG. 13 is a photographic image showing the thickness of the contact pad 40 of the touch screen panel 10 of FIG. 11.

Meanwhile, before the step of charging conductive ink in the horizontal groove array 410 and the vertical groove array 420, the surface of the upper plate 100 and lower plate 200 is hydrophobic-coated or UV-irradiated, thus adjusting the surface energy of a substrate provided with the horizontal groove array 410 and the vertical groove array 420.

Subsequently, a method of manufacturing a touch screen panel 10 according to an embodiment of the present invention will be described with reference to FIG. 14. The method of manufacturing a touch screen panel 10 includes the steps of: (S21) forming a mold having a shape corresponding to that of a horizontal groove array 410 or a vertical groove array 420; (S22) fabricating a transparent upper plate 100 having a horizontal groove array 410 including two or more horizontal grooves and a transparent lower plate 200 having a vertical groove array 420 including two or more vertical grooves using the mold; (S23) charging conductive ink in the horizontal groove array 410 and the vertical groove array 420 and then drying and sintering the conductive ink to form a conductive array 500; (S24-1) screen-printing one or more of the upper plate 100 and the lower plate 200 with a microscopic resin structure to form a spacer array 300; and (S25) attaching the upper plate 100 to the lower plate 200.

A method of manufacturing a touch screen panel 10 according to another embodiment of the present invention will be described. The method according to the above-embodiment is characterized in that a spacer array 300 is formed by screen-printing a resin structure, but the method according to this embodiment is characterized in that a spacer array is formed by applying a microball-dispersed or microcapsule-dispersed solution. The method of manufacturing a touch screen panel 10 according to this embodiment includes the steps of: (S21) forming a mold having a shape corresponding to that of a horizontal groove array 410 or a vertical groove array 420; (S22) fabricating a transparent upper plate 100 having a horizontal groove array 410 including two or more horizontal grooves and a transparent lower plate 200 having a vertical groove array 420 including two or more vertical grooves using the mold; (S23) charging conductive ink in the horizontal groove array 410 and the vertical groove array 420 and then drying and sintering the conductive ink to form a conductive array 500; (S24-2) coating one or more of the upper plate 100 and the lower plate 200 with a microball-dispersed or microcapsule-dispersed solution to form a spacer array 300; and (S25) attaching the upper plate 100 to the lower plate 200.

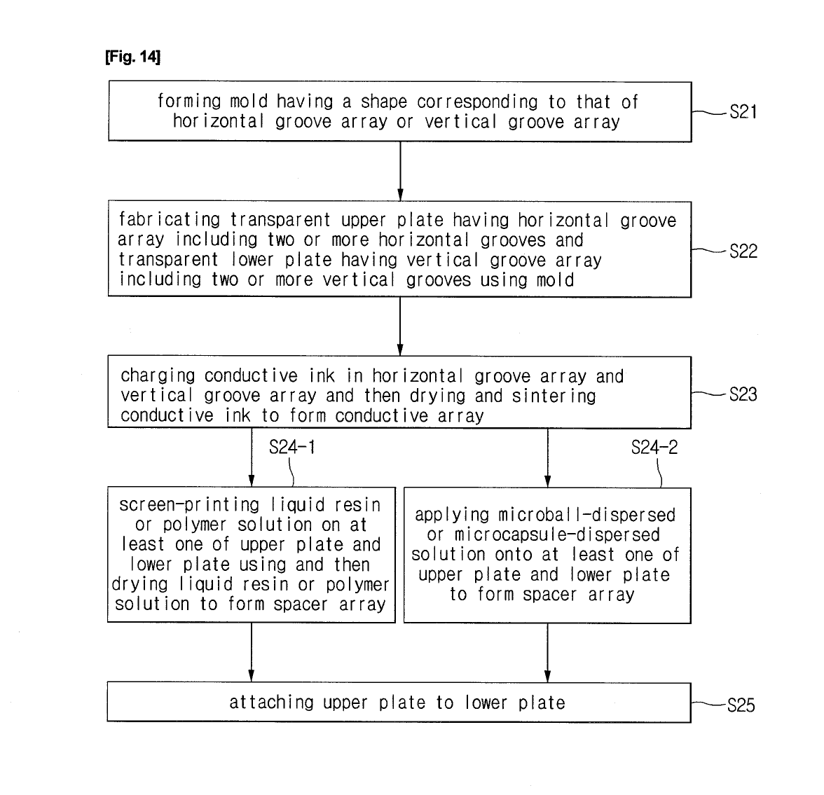

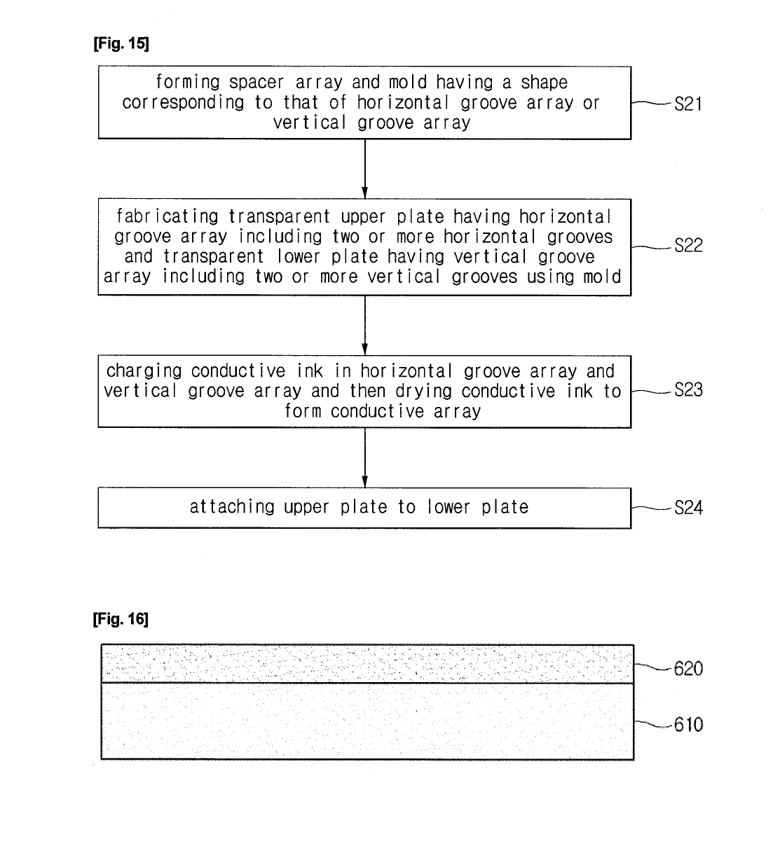

Subsequently, a method of manufacturing a touch screen panel 10 according to still another embodiment of the present invention will be described with reference to FIG. 15.

The method of manufacturing a touch screen panel 10 includes the steps of: (S31) forming a mold 695 having a shape corresponding to that of a horizontal groove array 410 or a vertical groove array 420; (S32) fabricating a transparent upper plate 100 having a horizontal groove array 410 including two or more horizontal grooves and a transparent lower plate 200 having a vertical groove array 420 including two or more vertical grooves using the mold 695; (S33) charging conductive ink in the horizontal groove array 410 and the vertical groove array 420 and then drying and sintering the conductive ink to form a conductive array 500; and (S34) attaching the upper plate 100 to the lower plate 200.

This method is characterized in that it does not need the step of forming a spacer array 300 because the spacer array 300 is formed on the upper plate 100 and/or the lower plate 200. The spacer array 300 is formed using the mold 695, simultaneously with the formation of the upper plate 100 and/or the lower plate 200. In this case, the spacer array 300, the horizontal groove array 410 and the vertical groove array 420 are formed using the mold 695 having a predetermined shape. The mold 695 is provided with both the spacer array and the channel-shaped groove pattern 400. Hereinafter, a method of fabricating the mold 695 will be described in detail with reference to FIGS. 16 to 30.

FIG. 16 is a sectional view showing a process of forming a photoresist (PR) 620 on a silicon wafer 610 using spin coating during a process of fabricating an ink-jet groove pattern master 625 using photolithography according to an embodiment of the present invention. In this process, if necessary, the silicon wafer is dehydrated and baked or is coated with hexamethylene disilazane (HMDS) prior to the spin coating to improve the adhesivity of photoresist 620. Further, if necessary, the silicon wafer is additionally soft-baked after the spin coating to improve the adhesivity of photoresist 620.

FIG. 17 is a sectional view showing a process of selectively UV-exposing the photoresist (PR) using a photomask during a process of fabricating an ink-jet groove pattern master 625 using photolithography according to an embodiment of the present invention. In this process, if necessary, the post exposure baking (PEB) of positive photoresist 620 is additionally performed to improve the adhesivity thereof.

FIG. 18 is a sectional view showing a process of partially removing the photoresist (PR) using development during a process of fabricating an ink-jet groove pattern master using photolithography according to an embodiment of the present invention. In this process, if necessary, hard baking is additionally performed to improve etch resistance.

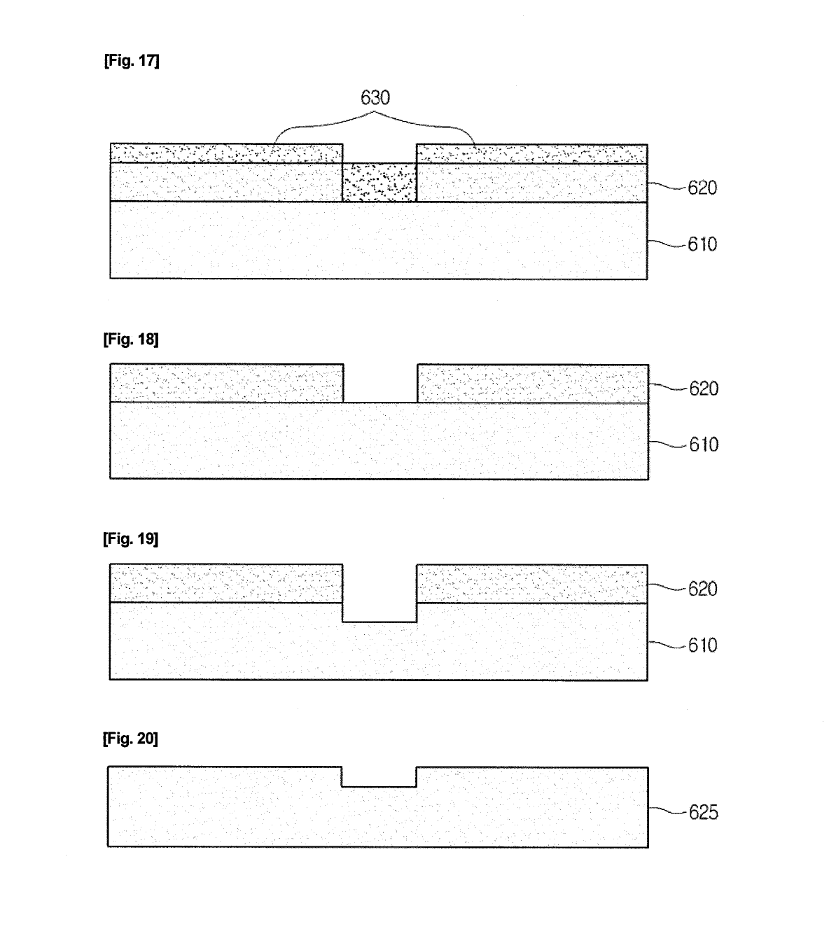

FIG. 19 is a sectional view showing a process of partially etching a silicon wafer 610 using reactive-ion etching (RIE) during a process of fabricating an ink-jet groove pattern master 625 using photolithography according to an embodiment of the present invention. In this process, the etch depth of the silicon wafer 610 may be adjusted by etching time.

FIG. 20 is a sectional view showing an ink-jet groove pattern master 625 formed after removing residual photoresist (PR) during a process of fabricating the ink-jet groove pattern master 625 using photolithography according to an embodiment of the present invention.

FIG. 21 is a sectional view showing a process of forming a photoresist (PR) on a silicon wafer using spin coating during a process of fabricating a spacer pattern master 310 using photolithography according to an embodiment of the present invention. In this process, if necessary, the silicon wafer is dehydrated and baked or is coated with hexamethylene disilazane (HMDS) prior to the spin coating to improve the adhesivity of photoresist 620. Further, if necessary, the silicon wafer is additionally soft-baked after the spin coating to improve the adhesivity of photoresist 620.

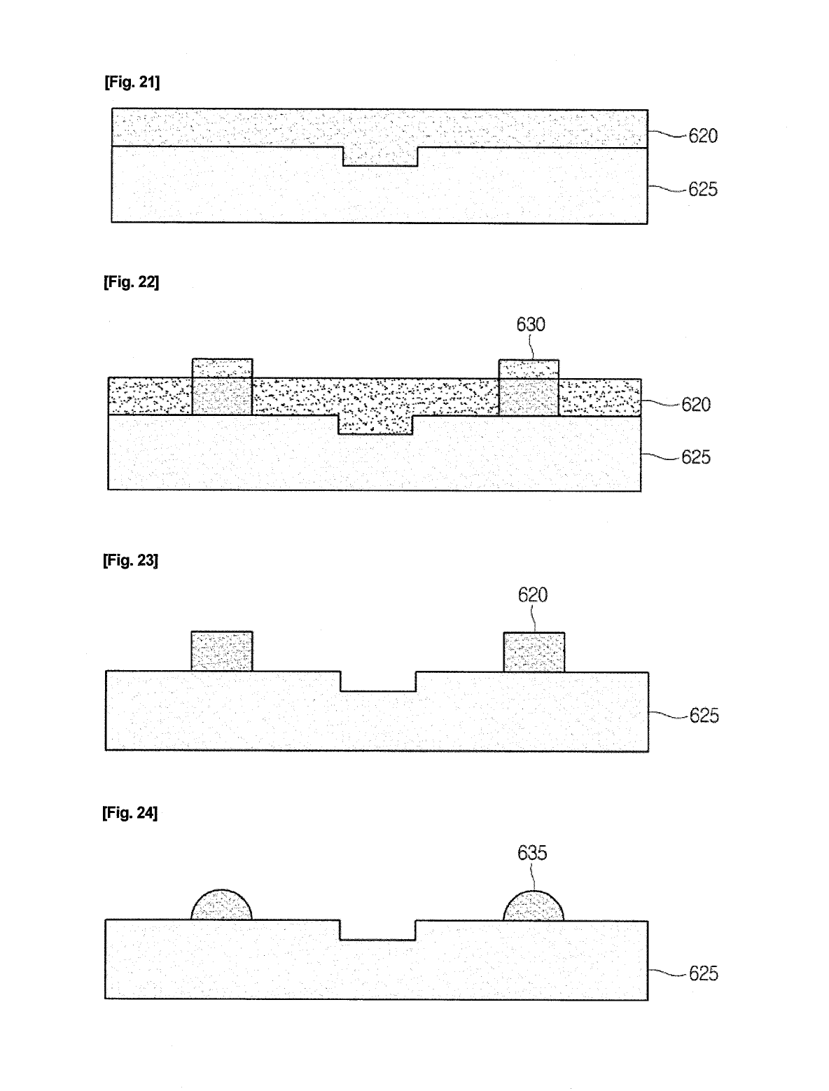

FIG. 22 is a sectional view showing a process of selectively UV-exposing the photoresist (PR) using a photomask during a process of fabricating a spacer pattern master using photolithography according to an embodiment of the present invention. In this process, if necessary, the post exposure baking (PEB) of positive photoresist 620 is additionally performed to improve the adhesivity thereof.

FIG. 23 is a sectional view showing a process of partially removing the photoresist (PR) using development during a process of fabricating a spacer pattern master using photolithography according to an embodiment of the present invention.

FIG. 24 is a sectional view showing a process of forming a spacer pattern through reflowing during a process of fabricating a spacer pattern master using photolithography according to an embodiment of the present invention. In this process, reflowing is performed in an oven, and, in this case, temperature and time are major variables.

FIG. 25 is a sectional view showing a process of depositing a nickel (Ni) seed layer 650 through nickel (Ni) evaporation during a process of fabricating a nickel (Ni) stamper 660 using electro-forming according to an embodiment of the present invention. Here, nickel (Ni) is an example of metal. In this process, a spacer pattern 310 and a photoresist pattern 620 may be changed depending on evaporation temperature. In order to prevent this phenomenon, spray-type silver coating may be used.

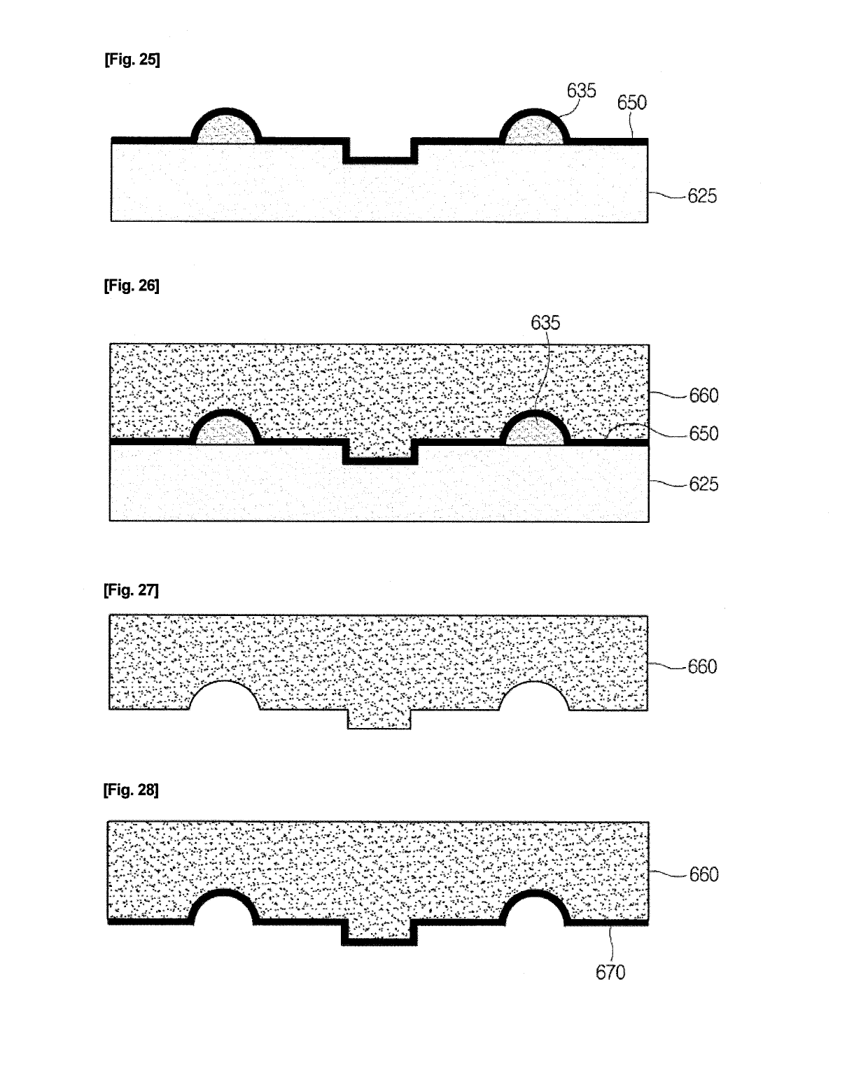

FIG. 26 is a sectional view showing a process of reproducing a pattern through nickel (Ni) electro-forming during a process of fabricating a nickel (Ni) stamper using electro-forming according to an embodiment of the present invention. In this process, the thickness of a nickel layer can be adjusted depending on electro-forming time.

FIG. 27 is a sectional view showing a nickel (Ni) stamper 660 reproduced after separating/removing a master during a process of fabricating the nickel (Ni) stamper 660 using electro-forming according to an embodiment of the present invention. From FIG. 27, it can be seen that a substrate (upper plate 100 or lower plate 200) of FIG. 30 provided with a spacer array 300 and a groove array 400 (horizontal groove array or vertical groove array) may be fabricated using the mold 695. FIGS. 28 to 30 show processes of fabricating the substrate of FIG. 30 using the mold 695 of FIG. 27.

FIG. 28 is a sectional view showing a process of applying an anti-sticking layer 670 through a self assembly monolayer (SAM) process during a process of fabricating a touch panel substrate using hot embossing according to an embodiment of the present invention. In this process, PECVD (plasma enhanced chemical vapor deposition) or VSAM (vapor self assembly monolayer) may be used. The anti-sticking layer 670 may be generally formed of FOTS (trichloro-(1H,1H,2H,2H perfluorooctyl) silane) or DDMS (dichlorodimethylsilane).

Further, the anti-sticking layer 670 may be unnecessary depending on the aspect ratio of a pattern.

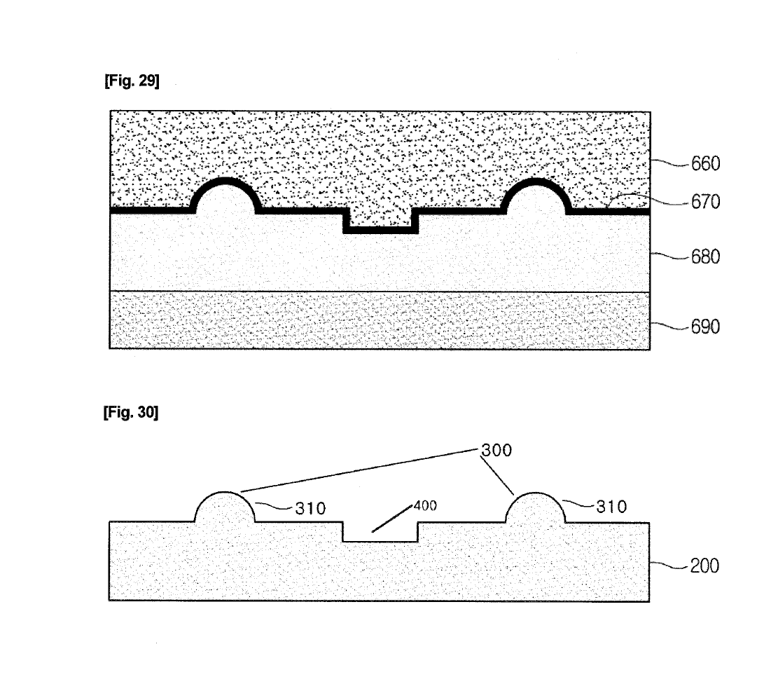

FIG. 29 is a sectional view showing a process of forming groove and spacer patterns through hot embossing during a process of fabricating a touch panel substrate using hot embossing according to an embodiment of the present invention. In this process, pressure and temperature are major process variables, and a thermoplastic polymer is generally used. As a thermoplastic polymer for the touch screen panel of the present invention, polyethylene naphthalate (PEN) may be used.

FIG. 30 is a sectional view showing a touch panel substrate fabricated after demolding during a process of fabricating the touch panel substrate using hot embossing according to an embodiment of the present invention. From FIG. 3, it can be seen that the touch panel substrate is provided with a spacer array 300 and a groove array 400. The touch panel substrate may be coated with the anti-sticking layer 670.

In order to accomplish the above objects, an aspect of the present invention provides a touch screen panel 10, manufactured by any one of the above-mentioned methods.

In order to accomplish the above objects, another aspect of the present invention provides a touch screen panel 10, including: a transparent upper plate 100 having a horizontal groove array 410 including two or more horizontal grooves having a channel shape of predetermined depth and width; a transparent lower plate 200 having a vertical groove array 420 including two or more vertical grooves having a channel shape of predetermined depth and width; an upper conductive array 530 formed in the horizontal groove array 410 of the upper plate 100 and made of conductive ink; a lower conductive array 500 formed in the vertical groove array 420 of the lower plate 200 and made of conductive ink; and a spacer array 300 formed on one or more of the upper plate 100 and the lower plate 200, wherein the upper plate 100 and the lower plate 200 are attached to each other.

The spacer array 300 is made of the same material as the upper plate 1000 or the lower plate 200, when the mold 695 is used. In this case, the spacer array 300 is integrated with the upper plate 100 or the lower plate 200 without the interfacial boundary therebetween. Since the spacer array 300 has a sufficient height, it preferred that the upper conductive array 530 and the lower conductive array 530-1 be spaced apart from each other at a predetermined interval as long as external pressure is not applied to one or more of the upper plate 100 and the lower plate 200.

### INDUSTRIAL APPLICABILITY

The present invention can be used in the industrial fields related to touch screen panels.

1. A method of manufacturing a touch screen panel, comprising the steps of:
(A) preparing a transparent upper plate having a horizontal groove array including two or more horizontal grooves having a channel shape of predetermined depth and width and a transparent lower plate having a vertical groove array including two or more vertical grooves having a channel shape of predetermined depth and width;
(B) charging conductive ink in the horizontal groove array and the vertical groove array and then treating the conductive ink to form a conductive array; and
(C) attaching the upper plate to the lower plate.

2. The method of claim 1, further comprising the step of forming a spacer array having a predetermined height on at least one of the upper plate and the lower plate.

3. The method of claim 2, wherein the spacer array is formed by any one of a first process micropatterning a liquid resin or polymer solution on at least one of the upper plate and the lower plate using screen printing and then drying the liquid resin or polymer solution and a second process of applying a microball-dispersed or microcapsule-dispersed solution onto at least one of the upper plate and the lower plate.

4. The method of claim 1, wherein the amount of the conductive ink is adjusted such that convex portions having a predetermined shape are formed in the horizontal grooves and vertical grooves.

5. The method of claim 1, wherein the conductive ink is treated by any one of a first process of heating the conductive ink to room temperature or predetermined temperature for predetermined time to dry the conductive ink and a second process of additionally heating the conductive ink dried in the first process using laser heat or electric heating to sinter the conductive ink to improve the conductivity thereof.

6. The method of claim 4, wherein the height of the convex portions is lower than that of the spacer array by a predetermined difference, and thus the convex portions of the upper plate are spaced apart from the convex portions of the lower plate such that they are brought into contact with each other even when the lower plate is attached to the lower plate.

7. The method of claim 1, wherein the conductive ink is charged using an inkjet printer.

8. The method of claim 1, wherein the conductive ink is at least one of metal nanoparticle ink and conductive polymer ink.

9. The method of claim 1, wherein the metal nanoparticle ink includes at least one of silver, copper and gold, and the conductive polymer ink includes at least one of poly(3,4-ethylenedioxythiophene) (PEDOT) and polyaniline (PANI).

10. The method of claim 1, wherein the diameter of droplets of the conductive ink is greater than the width of the channel shape when the conductive ink is charged.

11. The method of claim 1, further comprising the step of (B2) hydrophobic-coating the surface of the upper plate and the surface of the lower plate, before the step (B).

12. The method of claim 1, further comprising the step of (B3) UV-irradiating the surface of the upper plate and the surface of the lower plate, before the step (B).

13. The method of claim 1, wherein each of the upper plate and the lower plate is a flexible substrate, and is made by the thermal imprinting of a thermoplastic material or the UV molding of a UV-curable material.

14. The method of claim 1, wherein a spacer array is formed on at least one of the upper plate and the lower plate in the step (A), and the spacer array is made of the same material as the upper plate or the lower plate.

15. The method of claim 14, wherein the spacer array is formed simultaneously with the formation of the upper plate or the lower plate, and the spacer array, the horizontal groove array and the vertical groove array are formed using a mold having a predetermined shape.

16. The method of claim 15, wherein, when the engraved horizontal groove array, the engraved vertical groove array and the embossed spacer array are formed using the mold, the mold is coated with an anti-sticking layer, and then hot embossing is used.

17. The method of claim 15, wherein the mold is a nickel stamper, and the nickel stamper is fabricated by a process of fabricating an inkjet groove pattern master using photo-etching, a process of fabricating a spacer pattern master using photo-etching or a process of fabricating a nickel stamper using electro-forming.

18. A method of manufacturing a touch screen panel, comprising the steps of:
(D) forming a spacer array and a mold having a shape corresponding to that of a horizontal groove array or a vertical groove array;
(E) fabricating a transparent upper plate having a horizontal groove array including two or more horizontal grooves and a transparent lower plate having a vertical groove array including two or more vertical grooves using the mold;
(F) charging a predetermined amount of conductive ink in the horizontal groove array and the vertical groove array; and
(G) drying the conductive ink to form a conductive array and then attaching the upper plate to the lower plate.

19. The method of claim 18, wherein the step of forming the mold comprises the steps of:
(D1) forming a groove pattern master using photolithography;
(D2) forming a spacer pattern master using photolithography; and
(D3) forming a metal stamper using electro-forming.

20. A touch screen panel, manufactured by the method of claim 1, any-one of claims 1 to 19.

21. A touch screen panel, comprising:
a transparent upper plate having a horizontal groove array including two or more horizontal grooves having a channel shape of predetermined depth and width;
a transparent lower plate having a vertical groove array including two or more vertical grooves having a channel shape of predetermined depth and width;
an upper conductive array formed in the horizontal groove array of the upper plate and made of conductive ink;
a lower conductive array formed in the vertical groove array of the lower plate and made of conductive ink; and
a spacer array formed on at least one of the upper plate and the lower plate, wherein the upper plate and the lower plate are attached to each other.

22. The touch screen panel of claim 21, wherein the spacer array is made of the same material as the upper plate or the lower plate, and the spacer array is integrated with the upper plate or the lower plate without the interfacial boundary therebetween.

23. The touch screen panel of claim 21, wherein the spacer array is formed by applying a predetermined spacer forming material onto the upper plate or the lower plate.

24. The touch screen panel of claim 21, wherein the width of the channel shape is equal to or greater than the depth thereof.

25. The touch screen panel of claim 21, wherein the upper conductive array has convex portions protruding from the surface of the upper plate by a predetermined height, and the lower conductive array has convex portions protruding from the surface of the lower plate by a predetermined height.

26. The touch screen panel of claim 21, wherein the spacer array has a sufficient height, so the upper conductive array and the lower conductive array are spaced apart from each other at a predetermined interval as long as external pressure is not applied to at least one of the upper plate and the lower plate.

27. The touch screen panel of claim 21, wherein the upper plate and the lower plate are made of a flexible thermoplastic resin or a UV-curable material.

28. The touch screen panel of claim 21, wherein the conductive ink is at least one of metal nanoparticle ink and conductive polymer ink.

29. The touch screen panel of claim 21, wherein the spacer array is formed in two or more selected from among a plurality of lattice spaces forming the horizontal groove array and the vertical groove array, or the spacer array is formed with respect to each of a plurality of lattice spaces forming the horizontal groove array and the vertical groove array.

30. A touch screen panel, manufactured by the method of claim 18.
